(19) United States
(12) Patent Application Publication
(10) Pub. No.: US 2009/0298538 A1
(43) Pub. Date: Dec. 3, 2009

(54) MULTIFUNCTION MOBILE PHONE AND METHOD THEREOF

(75) Inventors: FEI GAO, Shenzhen City (CN); WEN-HAW TSENG, Tu-Cheng (TW); SHIH-FANG WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/472,385

(22) Filed: May 27, 2009

(30) Foreign Application Priority Data
May 30, 2008 (CN) 200810301858.6

(51) Int. Cl. H04M 1/00

(52) U.S. Cl. 455/556.1

(57) ABSTRACT

A multifunction mobile phone includes an accelerometer, a selection module, and a processor. The accelerometer detects a movement of the multifunction mobile phone, and generates acceleration signals in response to the movement. The selection module selects components of the acceleration signals in response to a selection signal. The processor receives the acceleration signals when no selection signal is inputted to the selection module, so as to control the multifunction mobile phone itself. The processor receives at least part of the acceleration signals through the selection module in response to the selection signal, so as to control the electronic device.

### BACKGROUND

1. Technical Field

The present disclosure generally relates to mobile phones, and particularly to a multifunction mobile phone capable of being a pointing device.

2. Description of Related Art

In general, a mobile phone is appropriately configured to provide voice and/or video communications. Although camera function and music function may be integrated with the mobile phone, the function of the mobile phone is still limited.

Therefore, a multifunction mobile phone is needed to address the aforementioned deficiency and inadequacies.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a multifunction mobile phone in accordance with an exemplary embodiment.

FIG. 2 is a more detailed block diagram of the multifunction mobile phone of FIG. 1 in accordance with an exemplary embodiment.

FIG. 3 is a flowchart of a method for operating the multifunction mobile phone in accordance with an exemplary embodiment.

### DETAILED DESCRIPTION

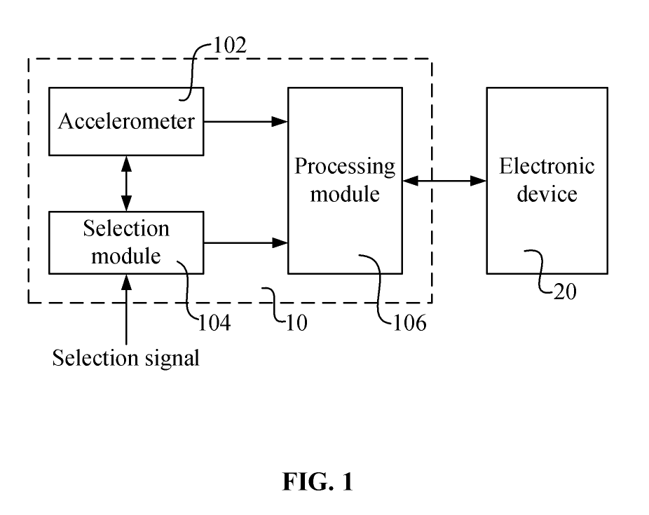

Referring to FIG. 1, a block diagram of a multifunction mobile phone 10 in accordance with an exemplary embodiment is illustrated. In addition to voice and/or video communication functions/features, the multifunction mobile phone 10 is also adoptable as a pointing device, such as a mouse for controlling an electronic device 20. The electronic device 20 may be a computer communicatively coupled to the multifunction mobile phone 10. For example, the electronic device 20 may connect with the multifunction mobile phone 10 based on wireless technology, such as BLUETOOTH®. The multifunction mobile phone 10 generally includes an accelerometer 102, a selection module 104, and a processor 106.

The accelerometer 102 is configured to detect a movement of the multifunction mobile phone 10, and generate acceleration signals indicating the movement correspondingly. In one exemplary embodiment, the accelerometer 102 is a three-axis accelerometer. The three-axis accelerometer 102 is capable of detecting the movement of the multifunction mobile phone 10 along three axes, i.e., an x-axis, a y-axis, and a z-axis, and generating an x-axis acceleration signal, a y-axis acceleration signal, and a z-axis acceleration signal correspondingly.

The selection module 104 may be a hardware component or a software component. In some implementations, the selection module 104 may be integrated with the processor 106. The selection module 104 is configured to receive the acceleration signals, select two of the acceleration signals and ignore the remaining acceleration signal in response to a selection signal. As used herein, the “selection signal” is defined for selecting/switching between different features/functions of the multifunction mobile phone 10. In a first case, when the selection signal is not inputted to the multifunction mobile phone 10, the multifunction mobile phone 10 provides a function/feature of voice and/or video communications normally. In a second case, when the selection signal is inputted to the multifunction mobile phone 10, the multifunction mobile phone 10 provides a function/feature of used as a mouse to control the electronic device 20. In some implementations, the multifunction mobile phone 10 may be provided with a push button for inputting the selection signal. When the multifunction mobile phone 10 is selected/switched to be a mouse, two keys of a keypad (not shown) of the multifunction mobile phone 10 may be particularly designated to perform left clicks and right clicks. In other embodiments, particular soft icons may be displayed in a display surface of a touch screen (not shown) to allow left clicks and right clicks.

The processor 106 is coupled to the accelerometer 102 and the selection module 104. When no selection signal is inputted to the selection module 104, the selection module 104 is disabled. The processor 106 processes the acceleration signals directly received from the accelerometer 102 to control the multifunction mobile phone 10 normally. For example, a ringtone of the multifunction mobile phone 10 may be changed when a predetermined movement is detected by the accelerometer 102.

When the selection signal is inputted to the selection module 104, the selection module 104 is enabled to select two of the acceleration signals and ignore the remaining acceleration signal. Because when the multifunction mobile phone 10 is configured as a pointing device, such as a mouse, only two of the acceleration signals are needed to move a cursor/pointer on a display screen of the electronic device 20 in two dimensional directions. The selection module 104 may select two of the acceleration signals according to predetermined directions. For example, two of the acceleration signals generated from the x-axis direction and the y-axis direction that are both in parallel to a display surface of a display screen may be selected. As such, the acceleration signal generated from the z-axis direction that is perpendicular to the display surface of a display screen is ignored. The processor 106 receives the two acceleration signals from the three-axis accelerometer 102, and converts the selected two acceleration signals into a first control signal and a second control signal. The first and second control signals are then sent to the electronic device 20 to control movements of the cursor/pointer on the display screen of the electronic device 20.

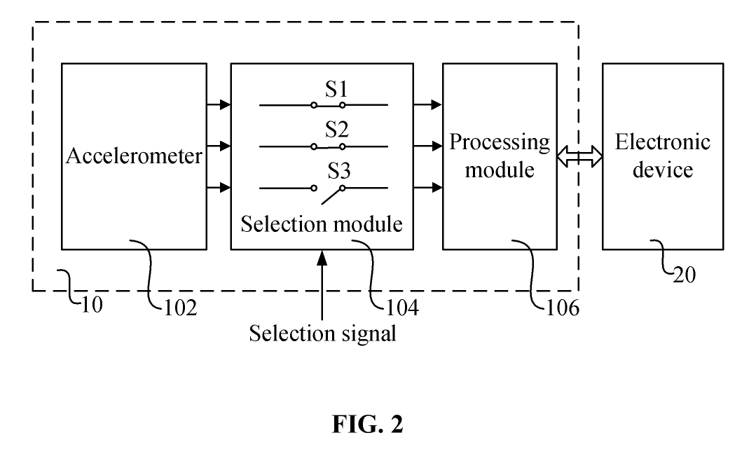

Referring to FIG. 2, a detailed block diagram of the multifunction mobile phone 10 in accordance with an exemplary embodiment is illustrated. In this embodiment, the selection module 105 includes a first switch S1, a second switch S2, and a third switch S3. Each of the three switches S1, S2, and S3 is connected between the three-axis accelerometer 102 and the processor 106. The first switch S1 is used to selectively transmit the x-axis acceleration signal to the processor 106 when the first switch S1 is turned ON. The second switch S2 is used to selectively transmit the y-axis acceleration signal to the processor 106 when the second switch S2 is turned ON. The third switch S3 is used to selectively transmit the z-axis acceleration signal to the processor 107 when the third switch S3 is turned ON.

In operation, when a selection signal is inputted to the selection module 104, two of the three switches S1, S2, S3 are turned ON to selectively transmit the accelerations signals to the processor 106 correspondingly. For example, the first switch S1 and the second switch S2 may be turned ON to transmit the x-axis and y-axis accelerations signals to the processor 106. The third switch S3 is turned OFF to prevent transmitting the z-axis acceleration signal to the processor 106. The processor 106 processes the accelerations signals to control the electronic device 20 accordingly.

As described above, the multifunction mobile phone 10 uses the accelerometer 102 to control both the multifunction mobile phone 10 and the external electronic device 20, thus, multiple functions/features are achieved.

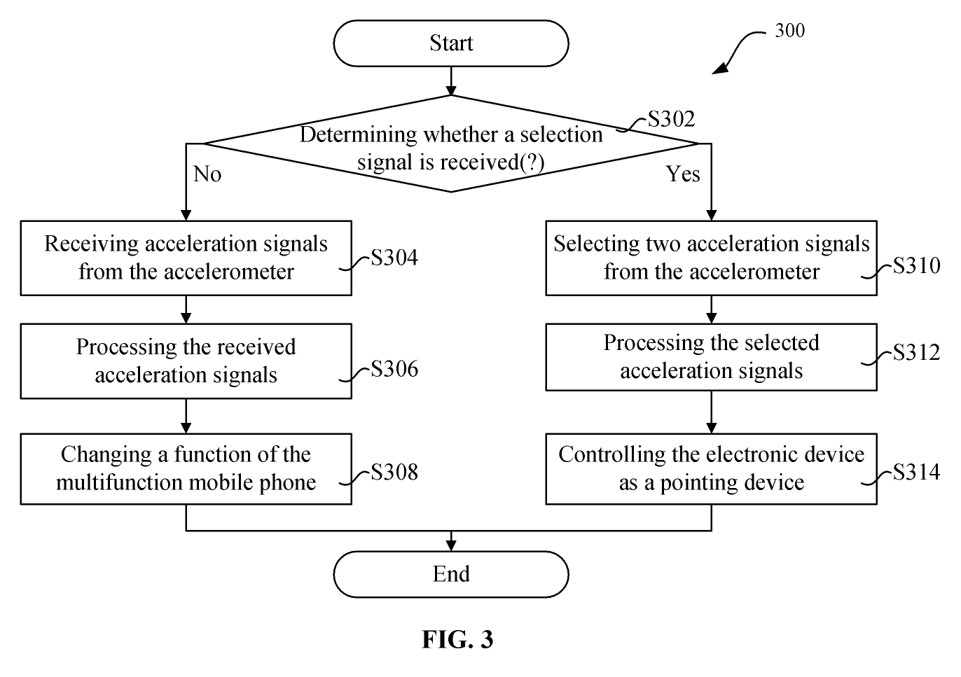

Referring to FIG. 3, a flowchart of a method 300 for operating the multifunction mobile phone 10 as a pointing device, such as a mouse to control the electronic device 20 of FIG. 1 in accordance with an embodiment is illustrated. The electronic device 20 may be a computer communicatively coupled to the multifunction mobile phone 10.

At block S302, the multifunction mobile phone 10 determines whether a selection signal is received. The selection signal is inputted for configuring the multifunction mobile phone 10 as a pointing device to control the electronic device 20. When the multifunction mobile phone 10 determines that the selection signal is received, the procedure goes to block S310. When the multifunction mobile phone 10 determines that the selection signal is not received, the procedure goes to block S304.

At block S304, the processor 106 of the multifunction mobile phone 10 receives acceleration signals directly output from the accelerometer 102. In particular, the processor 106 receives the x-axis, y-axis, and z-axis acceleration signals output from the accelerometer 102.

At block S306, the processor 106 processes the acceleration signals. In particular, the processor 106 processes the x-axis, y-axis, and z-axis acceleration signals to control the multifunction mobile phone 10 itself.

At block S308, the processor 106 changes a function of the multifunction mobile phone 10. In particular, the processor 106 changes a ringtone of the multifunction mobile phone 10 when a predetermined movement is detected by the accelerometer 102.

At block S310, the selection module 104 of the multifunction mobile phone 10 selects two acceleration signals from the accelerometer 102. In particular, the selection module 104 receives the x-axis, y-axis, and z-axis acceleration signals, passes two acceleration signals, and ignores the remaining acceleration signal. The two acceleration signals may be selected by two of the three switches S1, S2, and S3.

At block S312, the processor 106 processes the selected acceleration signals received through the selection module 104. In particular, the processor 106 converts the two acceleration signals into a first control signal and a second control signal.

At block S314, the first and second control signals are sent to the electronic device 20 to control movements of the cursor/pointer on the display screen of the electronic device 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multifunction mobile phone capable of controlling an electronic device, the electronic device being communicatively coupled to the multifunction mobile phone, the multifunction mobile phone comprising:
an accelerometer to detect a movement of the multifunction mobile phone, and generate acceleration signals in response to the movement;
a selection module coupled to the accelerometer, the selection module to select at least part of the acceleration signals in response to a selection signal for configuring the multifunctional mobile as a pointing device to control the electronic device; and
a processor coupled to the accelerometer and the selection module;
wherein the processor receives the acceleration signals when no selection signal is inputted to the selection module, the processor processes the acceleration signals to control the multifunction mobile phone so as to achieve a first function of the multifunction mobile phone,
wherein the processor also receives components of the acceleration signals though the selection module in response to the selection signal, the processor processes the selected acceleration signals to control the electronic device, so as to achieve a second function of the multifunction mobile phone.

2. The multifunction mobile phone of claim 1, wherein the accelerometer comprises a three-axis accelerometer, the three-axis accelerometer generates an x-axis acceleration signal, a y-axis acceleration signal, and a z-axis acceleration signal in response to the movement of the multifunction mobile phone, the selection modules selects two of the x-axis acceleration signal, the y-axis acceleration signal, and the z-axis acceleration signal in response to the selection signal.

3. The multifunction mobile phone of claim 2, wherein the selection module selects two of the three acceleration signals according to predetermined directions.

4. The multifunction mobile phone of claim 2, wherein the selection module comprises a first switch, a second switch, and a third switch, the first switch selectively transmits the x-axis acceleration signal to the processor, the second switch selectively transmits the y-axis acceleration signal to the processor, the third switch selectively transmits the z-axis acceleration signal to the processor.

5. The multifunction mobile phone of claim 4, wherein when the selection module receives the selection signal, two switches of the first switch, the second switch, and the third switch are turned ON to transmit the selected accelerations signals correspondingly.

6. The multifunction mobile phone of claim 1, wherein the processor converts the x-axis acceleration signal into the first control signal, and converts the y-axis acceleration signal into the second control signal when the x-axis and y-axis acceleration signals are selected by the select signal.

7. The multifunction mobile phone of claim 1, wherein the multifunction mobile phone is capable of being communicatively coupled to the electronic device via wireless technology.

8. The multifunction mobile phone of claim 7, wherein the wireless technology comprises BLUETOOTH.

9. A method for configuring a multifunction mobile phone as a pointing device to control an electronic device communicatively coupled to the multifunction mobile phone, the method comprising:
determining whether a selection signal being received by a selection module of the multifunction mobile phone;
detecting a movement of the multifunction mobile phone by an accelerometer to generate acceleration signals correspondingly;
processing the acceleration signals by a processor to control the multifunction mobile phone in response to the determination that the selection signal is not received, so as to achieve a first function of the multifunction mobile phone;
selecting two acceleration signals from the acceleration signals by the selection module in response to the determination that the selection signal is not received; and
converting the two acceleration signals into a first control signal and a second control signal by the processor, the first and second control signals being used to control the electronic device, so as to achieve a second function of the multifunction mobile phone.

10. The method of claim 9, wherein the action of detecting a movement of the multifunction mobile phone comprises:
detecting a movement of the multifunction mobile phone along an x-axis, a y-axis, and a z-axis to generate an x-axis acceleration signal, a y-axis acceleration signal, and a z-axis acceleration signal

11. The method of claim 9, wherein the action of selecting two acceleration signals comprises:
turning on a first switch to transmit the x-axis acceleration signal to the processor when the x-axis acceleration signal is selected; and
turning on a second switch to transmit the y-axis acceleration signal to the processor when the y-axis acceleration signal is selected.

12. The method of claim 9, wherein acceleration signals comprise an x-axis acceleration signal, a y-axis acceleration signal, and a z-axis acceleration signal, the x-axis acceleration signal is converted into a first control signal, and the y-axis acceleration signal is converted into a second control signal when the x-axis and y-axis acceleration signals are selected.
